(19) United States
(12) Patent Application Publication
(10) Pub. No.: US 2005/0132122 A1
(43) Pub. Date: Jun. 16, 2005

(54) Method, apparatus and system for monitoring system integrity in a trusted computing environment

(76) Inventor: Carlos V. Rozas, Portland, OR (US)

Correspondence Address: INTEL CORPORATION, P.O. BOX 5326, SANTA CLARA, CA, 95056-5326, US

(21) Appl. No.: 10/738,498

(22) Filed: Dec. 16, 2003

(51) Int. Cl. G06F 12/00

(52) U.S. Cl. 711/100

(57) ABSTRACT

A method, apparatus and system may monitor system integrity in a trusted computing environment. More specifically, in one embodiment, an integrity monitor in a root virtual machine (“VM”) may monitor guest software in a guest VM. The integrity monitor may securely maintain baseline information pertaining to the guest software and periodically (at predetermined intervals and/or based on predetermined events) compare the current state of the guest software against the baseline information. If the current state of the guest software is deemed to be compromised, the integrity monitor may be configured to take appropriate action, e.g., restrict the guest VM's access to resources. Additionally, according to one embodiment, the integrity monitor itself may be verified to determine whether it has been compromised.

### FIELD

The present invention relates to the field of computer security, and, more particularly to a method, apparatus and system for monitoring system integrity in a trusted computing environment.

### BACKGROUND

Computer security is becoming increasingly important, especially in corporate environments where security breaches may cause significant damage in terms of down time, loss of data, theft of data, etc. Various technologies have been developed to protect computers from security breaches to varying degrees of success. These protection measures, however, are themselves susceptible to attacks and may be compromised by those who are sufficiently knowledgeable about the technology used.

### BRIEF DESCRIPTION OF THE DRAWINGS

The present invention is illustrated by way of example and not limitation in the figures of the accompanying drawings in which like references indicate similar elements, and in which:

FIG. 1 illustrates a conceptual overview of an embodiment of the present invention;

FIG. 2 illustrates in further detail an integrity monitor according to an embodiment of the present invention; and

FIG. 3 is a flowchart illustrating an embodiment of the present invention.

### DETAILED DESCRIPTION

Embodiments of the present invention provide a method, apparatus and system for monitoring system integrity in a trusted computing environment. Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

Embodiments of the present invention enable monitoring of system integrity in a trusted computing environment. For simplicity, the following description assumes that the trusted computing environment includes processors incorporating Intel Corporation's LaGrande Technology (“LT™”) (LaGrande Technology Architectural Overview, published in September 2003) but embodiments of the invention are not so limited. Instead, various embodiments may be practiced within other similar trusted computing environments and any reference herein to “LT” and/or “LT platforms” shall include any and all such other environments. Additionally, only certain LT features are described herein in order to facilitate an understanding of embodiments of the present invention. LT may include various other features not described herein that are well known to those of ordinary skill in the art.

LT is designed to provide a hardware-based security foundation for personal computers (“PCs”), to protect sensitive information from software-based attacks. LT defines and supports virtualization, which allows LT-enabled processors to launch virtual machines (“VMs”), i.e., virtual operating environments that are isolated from each other on the same PC. Virtual machines are well known to those of ordinary skill in the art and further description thereof is omitted herein in order not to unnecessarily obscure embodiments of the present invention. LT defines and supports two types of VMs, namely a “root VM” and “guest VMs”. In an LT environment, the root VM runs in a protected partition and typically has full control of the PC when it is running and may enable creation of various virtual operating environments, each seemingly in complete control of the resources of the PC.

LT provides support for virtualization with the introduction of a number of elements. More specifically, LT includes a new processor operation called Virtual Machine Extension (VMX), which enables a new set of processor instructions on PCs. VMX enables two kinds of control transfers, called “VM entries” and “VM exits”, managed by a new structure called a virtual-machine control structure (“VMCS”). A VM exit in a guest VM causes the PC's processor to transfer control to a root entry point determined by the controlling VMCS. The root VM thus gains control of the processor on a VM exit and may take action appropriate in response to the event, operation, and/or situation that caused the VM exit. The root VM may then return to the context managed by the VMCS via a VM entry.

In one embodiment of the present invention, an integrity monitor may run in a protected partition (e.g., the root VM) on a host. The integrity monitor may be capable of monitoring the software running in the guest VMs. Typically, the root VM has no knowledge of the software in the guest VMs. Instead, the root VM may only perform resource allocation for the guest VMs and take action in response to events, operations and/or situations that cause VM exits (which cause the processor to transfer control to the root VM). According to an embodiment of the present invention, however, the root VM may include an integrity monitor capable of monitoring the software on the guest VMs and taking appropriate action if the software, and most critically the operating system, is deemed to be compromised in any way.

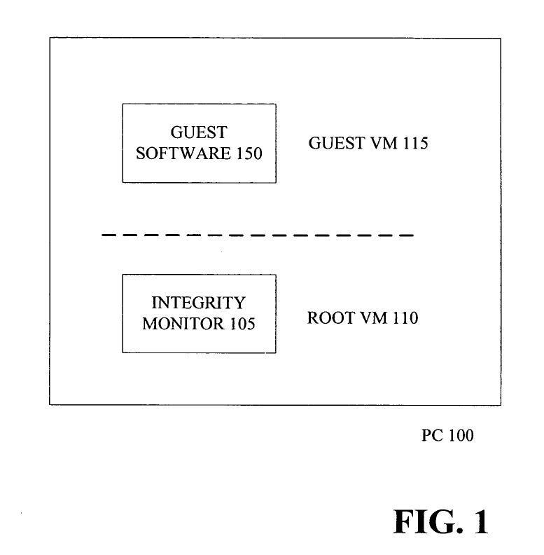

FIG. 1 illustrates a conceptual overview of an embodiment of the present invention. As illustrated, within PC 100 (an LT-enabled platform), Integrity Monitor 105 may exist in the root VM space (“Root VM 110”) while Guest Software 150 may reside in the guest VM space (“Guest VM 115”). Although only one guest software and one guest VM are illustrated, it will be readily apparent to those of ordinary skill in the art that embodiments of the invention are not so limited. Hereafter, any reference to Guest Software 150 shall include any and all operating systems and software running within each of the guest VMs on PC 100.

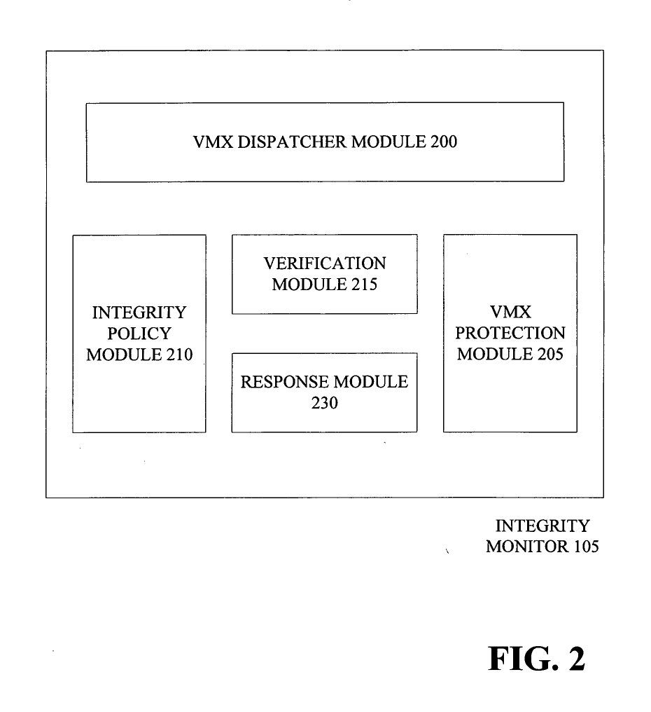

FIG. 2 illustrates Integrity Monitor 105 in further detail according to an embodiment of the present invention. Specifically, Integrity Monitor 105 may include various components, including VMX Dispatcher Module 200, VMX Protection Module 205, Integrity Policy Module 210, Verification Module 215 and Response Module 220. In one embodiment, Integrity Monitor 105 may be configured to monitor Guest Software 150 at predetermined intervals. In alternate embodiment, Integrity Monitor 105 may be triggered by a predetermined VMX event (e.g., events that may imply Guest Software 150's integrity has been compromised). VMX Dispatcher Module 200 and VMX Protection Module 205 may identify and handle VM exits and VM entries, and ensure that Guest Software 150, input output devices on PC 100 and/or system management code (“SMM”) do not tamper within operation of the root VM. Thus, for example, VMX Dispatcher Module 200 may handle all VM exits and VM entries, while VMX Protection Module 205 may generate an error message if Guest Software 150 (e.g, the operating system running on the guest VM) attempts to operate outside the bounds defined for the guest VM.

According to one embodiment of the present invention, Integrity Policy Module 210, Verification Module 215 and Response Module 220 may be responsible for monitoring Guest Software 150. More specifically, in one embodiment, various integrity rules may be defined within Integrity Policy Module 210, to configure how and when Integrity Monitor 105 monitors Guest Software 150. For example, in order to monitor Guest Software 150, Integrity Policy Module 210 may include a listing of all components of Guest Software 150 and “initial static baseline” information pertaining to these components. This initial static baseline information comprises information about the various components of Guest Software 150 prior to execution. In one embodiment, the initial static baseline information may be generated when the components are first installed on PC 100, prior to any possibility of corruption. In an alternate embodiment, a system administrator may provide the initial static baseline information manually to Integrity Policy Module 210 upon installation of the components. In yet another embodiment, these initial static baseline values may be retrieved from a storage location on PC 100 (e.g., from flash memory).

In one embodiment, a second set of baseline values may also be calculated. More specifically, when Guest Software 150 initially begins executing (i.e., at runtime), a set of “initial runtime baseline” values may also be calculated and stored. Both the initial static baseline and initial runtime baseline values may include, for example, information such as the checksum and/or values from other more sophisticated one-way hashing mechanisms such as MD5 and/or SHA1 applied to the components. MD5 and SHA1 are well known to those of ordinary skill in the art and further description thereof is omitted herein in order not to unnecessarily obscure embodiments of the present invention. Any references hereafter to “baseline values” shall include both initial static baseline values as well as initial runtime baseline values, unless otherwise specified.

Verification Module 215 may periodically process the components of Guest Software 150 and compare the processed values against the baseline values maintained by Integrity Policy Module 210. Thus, for example, Verification Module 215 may periodically perform a hash function on the components of Guest Software 150 during runtime and compare the hash values against the baseline values of the components in the list of components maintained by Integrity Policy Module 210. If the hash values match, Response Module 220 may inform the system administrator that Guest Software 150 has not been compromised. If, however, the hash values do not match, then Response Module 220 may be configured to inform the system administrator of the mismatch, restrict Guest Software 150's access to resources on PC 100 and/or other such action. In an alternate embodiment, Response Module 220 may send this information to a network “heartbeat” monitor, which in turn, may take appropriate action. The concept of network “heartbeat” monitors is well known to those of ordinary skill in the art and further description thereof is omitted herein.

Typically, in non-secure computing environments, the baseline hash values maintained by Integrity Policy Module 210 may be stored in PC 100's main memory, which is susceptible to tampering and attack from rogue software. The security features of LT platforms, however, facilitate a significantly higher degree of security in various embodiments of the present invention. Specifically, LT includes Trusted Platform Modules (“TPMs”) defined by the Trusted Computing Group (“TCG”) (Main Specification, Version 1.1a, published September 2001) that enable embodiments of the present invention to securely store the hash values of Guest Software 150. A TPM comprises processor-embedded hardware on PC 100 that includes platform configuration registers (“PCRs”) and secure cryptographic functions. Although the following description assumes the use of a TPM having specific security features, embodiments of the present invention are not so limited. Instead, other trusted hardware modules (similar to TPMs) may be implemented on various secure computing platforms and provide some, all or more features than the TPMs described herein. It will be readily apparent to those of ordinary skill in the art that embodiments of the present invention may also be modified for use with all such other trusted hardware modules.

The PCRs in the TPM may be used to securely store information. For example, each PCR may securely store baseline values pertaining to a component of Guest Software 150 (e.g., the operating system) and or a set of components (i.e., the hash value representing multiple component baseline values). Integrity Monitor 105 may thereafter utilize the baseline values to monitor Guest Software 150. In one embodiment, since Integrity Monitor 105 may be a software-based application, it may itself be susceptible to attack. To ensure that Integrity Monitor 105 is verified (i.e., uncompromised), according to embodiments of the present invention, the PCRs may also be used to store information (e.g., startup hash values) corresponding to a verified Integrity Monitor 105. When PC 100 is initially booted up, various startup events may occur. In one embodiment, one of these startup processes (e.g., an operating system loader process) may measure a hash value of Integrity Monitor 105 and store the value in a PCR on the TPM. Thereafter, when Integrity Monitor 105 attempts to access other values on the various PCRs in the TPM, the startup hash value of Integrity Monitor 105 may be used to authenticate that Integrity Monitor 105 is verified (i.e., that it has not been tampered with) and thereafter, Integrity Monitor 105 may access the securely stored values.

In addition to VMX, LT platforms include a feature known as Secure Machine Execution (“SMX”), which provides an additional level of security. SMX provides PC 100 with an additional layer of protection to PC 100 by setting up protection barriers to PC 100's resources. SMX enables PC 100 to perform a “secure launch” which provides, amongst other things, hardware protection against direct memory access (“DMA”). Thus, for example, SMX ensures that Root VM 110 maintains control of PC 100's resources by marking the memory used by the System Virtual Machine Monitor (“SVMM” i.e., the system code that Root VM 110 operates in SMX mode) as protected memory, unavailable to DMA access. SVMM is well known to those of ordinary skill in the art and further description thereof is omitted herein. Significantly, for the present purposes, according to one embodiment of the present invention, while PC 100 is executing in SMX mode, an initialization module (“SINIT”) may measure and store the hash values of Integrity Monitor 105 in a secure memory area (e.g., the TPM), without any DMA access. Thereafter, Integrity Monitor 105 may be verified by further examining the values maintained by SINIT in the TPM.

While in SMX mode, Integrity Monitor 105 may also impose restrictions on certain areas of PC 100's memory and designate those areas as non-writable, i.e., protected memory, unavailable to DMA access by input/output (“I/O”) devices and/or software running on PC 100. In one embodiment of the present invention, certain components of Guest Software 150 may be placed into this area of non-writable memory, which provides them with yet another layer of protection against tampering. For example, the kernel code on PC 100 (are we talking about OS kernel here?), which is unlikely to change during runtime, may be executed in this non-writable memory area.

Additionally, since only a limited number of PCRs exist in the TPM, Integrity Monitor 105 may run out of space to store the hash values of the various components of Guest Software 150. In one embodiment, the contents of certain PCRs may be written into the non-writable memory area on PC 100, thus effectively expanding the secure storage available to Integrity Monitor 105, to store additional hash values. Although not as secure as the PCRs, the non-writable memory area nonetheless provides more protection against tampering than if the values were stored in unprotected memory (as is typical in current non-secure computing environments).

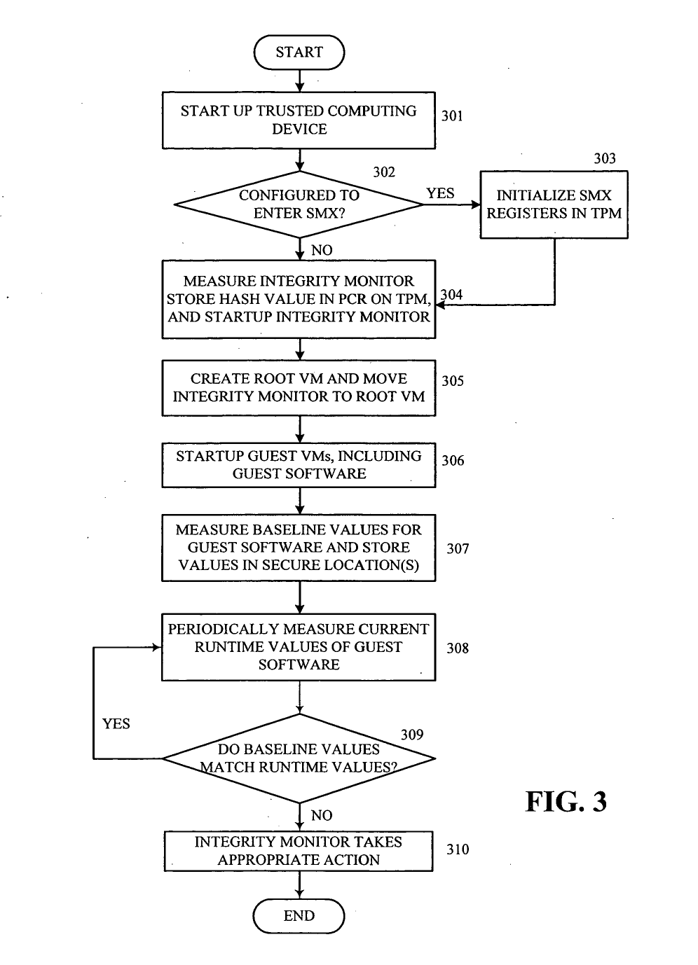

FIG. 3 is a flow chart illustrating an embodiment of the present invention. Although the following operations may be described as a sequential process, many of the operations may in fact be performed in parallel and/or concurrently. In addition, the order of the operations may be re-arranged without departing from the spirit of embodiments of the invention. In 301, a trusted computing device may start up. If the trusted computing device is configured to enter into SMX mode in 302, the PCRs in the TPM corresponding to SMX may be initialized (i.e., populated with various startup values created during the secure launch process) in 303 and the integrity monitor may be measured, its corresponding hash value may be stored in a PCR in the TPM on the trusted computing device and the integrity monitor may then start up in 304. If, however, the trusted computing device is not configured to enter into SMX mode in 303, the integrity monitor may simply be measured, its corresponding hash value may be stored in a PCR in the TPM on the trusted computing device and the integrity monitor may then start up in 304. In 305, the integrity monitor may create a root VM and move itself into the root VM. Various guest VMs (including guest software) may be started up in 306 and the integrity monitor may measure baseline values corresponding to the software on the guest VMs and store the baseline values in various secure locations 307 (e.g., the PCRs on the TPM and/or non-writable memory areas on PC 100). The integrity monitor may thereafter in 308 monitor the software values in the TPM periodically during runtime (according to a variety of methodologies, e.g., predetermined time intervals, random intervals and/or triggered by events, etc.), to ensure the software has not been compromised. If baseline hash values do not match the current runtime hash values in 309, the guest software may be deemed compromised and the integrity monitor may be configured to take appropriate action in 310.

Although described as being implemented on PCs, embodiments of the present invention may be implemented on a variety of trusted computing devices. According to an embodiment of the present invention, these computing devices may include various components capable of executing instructions to accomplish an embodiment of the present invention. For example, the computing devices may include and/or be coupled to at least one machine-accessible medium. As used in this specification, a “machine” and/or “trusted computing device” includes, but is not limited to, any computing device with one or more processors. As used in this specification, a “machine-accessible medium” and/or a “medium accessible by a trusted computing device” includes any mechanism that stores and/or transmits information in any form accessible by a computing device, including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals).

According to an embodiment, a computing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. A host bus controller such as a Universal Serial Bus (“USB”) host controller may be coupled to the bus(es) and a plurality of devices may be coupled to the USB. For example, user input devices such as a keyboard and mouse may be included in the computing device for providing input data.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

1. A method of monitoring software executing on a trusted computing device comprising:
generating in a protected partition on the trusted computing device baseline information pertaining to guest software in a guest virtual machine;
storing the baseline information in a secure memory area;
processing the guest software during runtime according to a predefined methodology to determine current runtime information; and
comparing the current runtime information to the baseline information stored in the secure memory area to determine whether the guest software has been compromised.

2. The method according to claim 1 wherein generating the baseline information further comprises performing a hash function on the guest software to obtain a hash value.

3. The method according to claim 2 wherein performing the hash function on the guest software includes performing a hash function on one of each component of the guest software and a collection of components of the guest software.

4. The method according to claim 2 wherein performing the hash function on the guest software to obtain the hash value further comprises at least one of performing the hash function on the guest software prior to execution to obtain an initial static baseline value and performing the hash function on the guest software immediately upon execution to obtain an initial runtime baseline value.

5. The method according to claim 4 wherein processing the guest software during runtime according to a predefined methodology further comprises performing the hash function periodically on the guest software during runtime to obtain a current hash value.

6. The method according to claim 5 wherein comparing the current runtime information to the baseline information further comprises comparing the current hash value to the baseline hash value.

7. The method according to claim 1 wherein generating the baseline information comprises retrieving the baseline information from a storage location on the trusted computing device.

8. The method according to claim 1 wherein storing the baseline information in the secure memory area further comprises storing the hash value in a trusted platform module (“TPM”).

9. The method according to claim 1 further comprising performing a secure launch of the trusted computing platform prior to generating the baseline information.

10. The method according to claim 9 wherein storing the baseline information in the secure memory area further comprises storing the hash value in one of a TPM and a designated non-writable memory area.

11. The method according to claim 9 further comprising executing at least a portion of the guest software in a designated non-writable memory area.

12. The method according to claim 1 wherein the predefined methodology includes at least one of a checksum, MD5 and SHA1.

13. The method according to claim 1 wherein the protected partition includes a root virtual machine.

14. A method of monitoring the integrity of a trusted computing device, comprising:
launching a protected partition and a guest virtual machine on the trusted computing device;
executing an integrity monitor in the protected partition and guest software in the guest virtual machine;
the integrity monitor processing the guest software in the guest virtual machine to generate a baseline hash value;
storing the baseline value in a secure memory area;
the integrity monitor periodically processing the guest software while executing to generate a current hash value; and
the integrity monitor comparing the baseline hash value in the secure memory area to the current hash value to determine whether the guest software has been compromised.

15. The method according to claim 14 wherein storing the baseline value in a secure memory area includes storing the baseline value in at least one of a trusted platform module (“TPM”) and a designated non-writable memory area.

16. The method according to claim 14 further comprising processing and storing a value corresponding to the integrity monitor.

17. The method according to claim 16 further comprising verifying the integrity monitor prior to comparing the baseline hash value to the current hash value.

18. The method according to claim 14 wherein processing the guest software in the guest virtual machine to generate the baseline hash value includes retrieving the baseline hash value from a storage location.

19. The method according to claim 14 wherein launching a protected partition includes launching a root virtual machine.

20. A system for monitoring software integrity, comprising:
a trusted computing device
a protected partition machine running on the trusted computing device;
a guest virtual machine running on the trusted computing device, the guest virtual machine including guest software;
a secure memory area on the trusted computing device; and
an integrity monitor executing within the protected partition, the integrity monitor capable of generating a baseline hash value for the guest software initially, and a current hash value for the guest software during runtime, the integrity monitor further capable of storing the baseline hash value in the secure memory area, the integrity monitor further capable of comparing the baseline hash value and the current hash value to determine if the guest software has been compromised.

21. The system according to claim 20 wherein the secure memory area includes a trusted platform module (“TPM”).

22. The system according to claim 20 wherein the trusted computing device may calculate a hash value for the integrity monitor and store the hash value for the integrity monitor in the secure memory area.

23. The system according to claim 22 wherein the hash value for the integrity monitor may be used to verify the integrity monitor prior to enabling the integrity monitor to access the baseline hash value stored in the secure memory area.

24. The system according to claim 21 wherein the trusted computing device executes in Secure Execution Machine (“SMX”) mode and the secure memory area includes one of the TPM and a designated non-writable memory area.

25. The system according to claim 24 wherein a secure launch module may calculate a hash value for the integrity monitor and store the hash value for the integrity monitor in the secure memory area.

26. An article comprising a medium accessible by a trusted computing device, the medium having stored thereon instructions that, when executed by the trusted computing device, cause the trusted computing device to:
generate in a protected partition baseline information pertaining to components of guest software in a guest virtual machine;
store the baseline information in a secure memory area;
process the guest software during runtime according to a predefined methodology to determine current runtime information; and
compare the current runtime information to the baseline information stored in the secure memory area to determine whether the guest software has been compromised.

27. The article according to claim 26 wherein the instructions, when executed by the trusted computing device, further cause the trusted computing device to perform a hash function on the guest software to obtain a hash value.

28. The article according to claim 27 wherein perform a hash function on one of each component of the guest software and a collection of components of the guest software.

29. The article according to claim 27 the instructions, when executed by the trusted computing device, further cause the trusted computing device to at least one of: perform the hash function on the guest software prior to execution to obtain an initial static baseline value and perform the hash function on the guest software immediately upon execution to obtain an initial runtime baseline value.

30. The article according to claim 29 wherein the instructions, when executed by the trusted computing device, further cause the trusted computing device to perform the hash function periodically on the guest software during runtime to obtain a current hash value.

31. The article according to claim 30 wherein the instructions, when executed by the trusted computing device, further cause the trusted computing device to compare the current hash value to the baseline hash value.

32. The article according to claim 26 wherein the instructions, when executed by the trusted computing device, further cause the machine to retrieve the baseline information from a storage location on the trusted computing device.

33. The article according to claim 26 wherein the instructions, when executed by the trusted computing device, further cause the trusted computing device to store the hash value in a trusted platform module (“TPM”).

34. The article according to claim 26 wherein the instructions, when executed by the trusted computing device, further cause the trusted computing device to perform a secure launch of the trusted computing platform prior to generating the baseline information.

35. The article according to claim 34 wherein the instructions, when executed by the trusted computing device, further cause the trusted computing device to store the baseline value in one of a TPM and a designated non-writable memory area.

36. The article according to claim 34 the instructions, when executed by the trusted computing device, further cause the trusted computing device to execute at least a portion of the guest software in a designated non-writable memory area.

37. The article according to claim 26 wherein the protected partition includes a root virtual machine.
